(19) United States
(12) Patent Application Publication
(10) Pub. No.: US 2011/0231024 A1
(43) Pub. Date: Sep. 22, 2011

(54) Methods, Processes, of Smart Check Valve Flow Assurance Monitoring in Production and Injection of Fluids in a Digital Oilfield

(76) Inventor: Masoud Medizade, San Luis Obispo, CA (US)

(21) Appl. No.: 13/072,816

(22) Filed: Mar. 28, 2011

Related U.S. Application Data
(63) Continuation of application No. 10/760,437, filed on Jan. 20, 2004, now Pat. No. 7,634,328.
Application No. 10/760,437 is a continuation of application No. 12/636,781, filed on Dec. 14, 2009, now abandoned.

(51) Int. Cl. G05D 7/06; F16K 51/00

(52) U.S. Cl. 700/282; 137/15.18

(57) ABSTRACT

An arrangement which utilizes an improved combination and a simple local supervisory control system to monitor and/or control the operation of a positive displacement pump used to extract petroleum from geologic strata. The local supervisory control system controls the operation of an electric motor which drives a reciprocating positive displacement pump so as to maximize the volume of petroleum extracted from the well per pump stroke while minimizing electricity usage and pump-off situations. By reducing the electrical demand and pump-off (i.e., “pounding” or “fluid pound”) occurrences, operating and maintenance costs should be reduced sufficiently to allow petroleum recovery from marginally productive petroleum fields. The local supervisory control system includes one or more applications to at least collect flow signal data generated from a sensor check valve that incorporates pressure, temperature, and flow rate measurements.

### RELATED APPLICATIONS

This application is continuation of and claims the benefit of and priority to U.S. application Ser. No. 10/760,437 filed Jan. 20, 2004 by Masoud Medizade et. al. now issued as U.S. Pat. No. 7,634,328, and U.S. application Ser. No. 12/636,781 filed Dec. 14, 2009 by (Mason) Masoud Medizade, the contents of which are hereby incorporated by reference as if recited full herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention relates generally to a data processing method, system and computer program product and more specifically to a low cost method, system and computer program product for monitoring and optimizing fluid extraction from geologic strata. The invention further provides energy savings and limits pumping equipment wear and tear by minimizing pump runoff conditions.

### BACKGROUND

Maximizing the recovery of petroleum from marginally productive domestic oil fields is important to U.S. energy independence goals and national security interests. However, in order to be competitive with imported petroleum, the domestic petroleum must be recovered in a cost efficient manner in order to be commercially viable. Traditionally, techniques for (the) pumping of petroleum involved either continuously operating a pump unit or controlling the pumping unit with a simple electromechanical timer to avoid peak electrical energy charges. Neither of these techniques is suitable for optimizing the extraction of petroleum from marginally productive oil fields.

Furthermore, these techniques waste electrical energy and cause excessive wear and tear on the pumping equipment, thus increasing operational and maintenance costs which decrease(s) the economic viability of the operation. As a result, marginally productive oil fields are often underutilized due to the high electrical energy costs incurred and resulting low production yields (resulting) from the production wells.

In order to efficiently extract petroleum from these marginal oil fields, a system should be employed which detects when a pumping system encounters an abnormal pumping situation. For example, a commonly encountered abnormal pumping situation is known as “fluid pound”.

Fluid pound occurs when the production well is pumped-off, i.e., when petroleum is extracted from a well at a rate greater than the rate at which the petroleum is recharged by the petroleum bearing formation. In a pump-off situation, a working well is only partially filled during the upstroke of a plunger. Upon the plunger's downstroke, the plunger strikes or “pounds” the remaining fluid in the working barrel causing severe jarring of the entire pumping unit which may lead to damage of the pumping unit and decreased pumping efficiency.

Many solutions are known in the relevant art to address the pump-off situations in a petroleum production environment. For example, several references teach measuring changes in the load on a reciprocating member associated with a downhole pump; U.S. Pat. No. 3,838,597 to Montgomery, et al.; U.S. Pat. No. 4,286,925 to Standish; U.S. Pat. No. 5,044,888 to Hester; U.S. Pat. No. 6,155,347 to Mills; measuring current and voltage phase relationships associated with an electrical driving motor U.S. Pat. No. 5,362,206 to Westerman, et al.; measuring the instantaneous rate of both pulsating and steady-state flow; U.S. Pat. No. 5,006,044 to Walker et al.; measuring vibrations incident on reciprocating member associated with a downhole pump, SPE 62865, “Marginal Expense Oil Well Wireless Monitoring,” D. Nelson, H. Trust, Society of Petroleum Engineers, 2000; sonically measuring pump-off, U.S. Pat. No. 4,171,185 to Duke, et al.; and expensive hybrid computer controlled systems monitoring a plurality of pump operating parameters, U.S. Pat. No. 5,941,305 to Thrasher, et al.

Although many of these solutions may be effective, these solutions tend to have one or more disadvantages including requiring expensive monitoring equipment, requiring frequent calibration and/or requiring frequent maintenance in the corrosive and (toxic) environment of marginally productive petroleum fields. As such, the added incremental costs of providing one or more of these solutions generally limit their application to larger and more productive fields. Smaller and marginally productive fields necessarily require low cost and low maintenance solutions in order to be economically viable.

Therefore, it would be highly advantageous to provide a simple, low cost monitoring and control system which maximizes recovery of petroleum, minimizes energy usage and requires minimal ongoing maintenance.

### SUMMARY

This invention addresses the limitations described above and provides in a first embodiment, a method for monitoring and optimizing fluid extraction from geological strata which comprises coupling a flow transducer to a flap valve (either pre-existing or newly installed) to a discharge conduit associated with a positive displacement pump. The flow transducer is designed to generate flow signals by detecting movement and position detectable flap element internal to the flap valve by way of one or more different sensing mechanisms including variable reluctance effects, Hall effects, magnetic inductance effects, binary switch states, potentiometer outputs or piezoelectric effects. The position detectable flap element includes means (mechanical, electrical or magnetic) for stimulating the flow transducer to generate the flow signals coincident with movement of the flap element.

The method embodiment of the invention further provides for electromagnetically coupling the flow transducer to a local supervisory control system, monitoring the flow signals at least during operation of the positive displacement pump, accumulating at least a portion of the flow signals in a memory associated with the local supervisory control system, and determining an optimum pumping cycle from the accumulated flow signals.

In a related method embodiment, an arrangement is provided for transferring at least a portion of the accumulated flow signals from the local supervisory control system to a centralized supervisory control system, outputting the optimized pumping cycle in a format useful for optimizing fluid extraction from the geological strata using the positive displacement pump.

The flow signal transfer process may be accomplished using a telecommunications link, a laptop computer, a personal data assistant, or a data logging device, the flow data transferred from which are then retrievably stored in a data store associated the centralized supervisory control system. The telecommunications link may include electrical, optical, radio frequency or a combination thereof.

In another related method embodiment, an arrangement is provided for electromagnetically coupling a motor controller associated with the positive displacement pump to the local supervisory control system, generating a control signal if the flow signals fall outside a predetermined range or predetermined set point, sending the control signal to the motor controller, and changing an operating state of the positive displacement pump by the motor controller upon receipt of the control signal. The aforementioned predetermined range and predetermined set point includes low or loss of fluid flow and a flow duration in which the positive displacement pump has been operating or idle respectively. The operating state of the positive displacement pump may be turned on or off, change pump speed, based on information derived from the flow signals.

In another method embodiment, the invention further provides for determining an optimum pumping cycle from the accumulated flow signals, and outputting the optimized pumping cycle in a format useful for optimizing fluid extraction from the geological strata.

In a systematic embodiment of the invention, a system for monitoring and optimizing fluid extraction from geological strata is provided which comprises: a flow transducer coupled to a flap valve (either pre-existing or newly installed). The flow transducer is designed to generate flow signals by detecting movement of a position detectable flap element internal to the flap valve by way of one or more different sensing mechanisms including variable reluctance effects, Hall effects, magnetic inductance effects, binary switch states, potentiometer outputs or piezoelectric effects.

The position detectable flap element includes means (mechanical, electrical or magnetic) for stimulating the flow transducer to generate the flow signals coincident with movement of the flap element. By way of example, the position detectable flap element includes one or more permanent magnets attached thereto and arranged to stimulate the flow transducer to generate the flow signals coincident with flow induced movement of the position detectable flap element. The system further provides for a local supervisory control system which is electromagnetically coupled to the flow transducer. The local supervisory control system includes; a first processor; a first memory coupled to the first processor; and an application operatively stored in a portion of the first memory having logical instructions executable by the first processor to; monitor the flow signals generated by the flow transducer during operation of the positive displacement pump, accumulate the flow signals in another portion of the first memory and transfer the accumulated flow signals to an electronic transport medium. Transferring of the accumulated flow signals may occur automatically based at least in part on time, in response to a transfer request issued by the centralized supervisory control system or in response to an event (flow based, detected error condition or coupling of the electronic transport medium to the local supervisory control system.)

The electronic transport medium includes a telecommunications link, a laptop computer, a personal data assistant, or a data logging device. The telecommunications link may include electrical, optical, radio frequency or a combination thereof. In an embodiment of the invention, the telecommunications link is a wireless network.

In a related systematic embodiment, the invention further comprises: a centralized supervisory control system including; a second processor; a data storage coupled to the second processor; a second memory coupled to the second processor; and another application operatively stored in a portion of the second memory having logical instructions executable by the second processor to; receive the accumulated flow signals from the electronic transport medium, retrievably store the accumulated flow signals in the data storage and output the accumulated flow signals in a format useful for optimizing fluid extraction from the geological strata using the aforementioned positive displacement pump.

In another related systematic embodiment, the application associated with the local supervisory control system further includes instructions executable by the first processor for; transmitting a control signal to an electromagnetically coupled motor controller associated with the positive displacement pump if the flow signals fall outside a predetermined range or predetermined set point.

The aforementioned predetermined range and predetermined set point includes low or no flow and a flow duration in which the positive displacement pump has been operating or idle respectively. The operating state of the positive displacement pump may be turned on or off based on information derived from the flow signals.

In a systematic embodiment of the invention, the motor controller includes a timer mechanism for turning the positive displacement pump on or off in accordance with a programmed pumping cycle which can be modified either manually or automatically to utilize the determined optimized pumping cycle.

In another systematic embodiment, the invention provides for generating a control signal if the flow signals fall outside the predetermined range, the flow signals fall outside the predetermined set point, or a control command is received from the centralized supervisory control system. The control command may be generated by the central supervisory control system periodically (time-based) or as a result of an event (flow based or detected error state.)

In a computer program product embodiment of the invention, the invention compromises a computer program product embodied in a tangible form readable by a processor having executable instructions stored thereon for causing the processor to: monitor flow signals generated by a flow transducer, accumulate at least a portion of the flow signals in a memory coupled to the processor, transmit a control signal to an electromagnetically coupled motor controller if the flow signals fall outside a predetermined range or predetermined set point, transfer at least a portion of the accumulated flow signals over a network to another processor, and output the accumulated flow signals in a format useful for optimizing fluid extraction from geological strata using a positive displacement pump.

The programs and associated data may be stored in semi-conductor storage media, transportable digital recording media such as a CD ROM, floppy disk, data tape, DVD, or removable hard disk for installation on the centralized supervisory control system or local supervisory control system as one or more transportable computer program products. The programs and associated data comprise executable instructions which are stored in a code format including byte code, compiled, interpreted, compliable or interpretable.

Further the inventive subject matter incorporates a modified sensor check valve flow monitoring system that can be used with different design and different sizes of check valves. Existing check valves can be modified with electronics or electronics can be added to new valves.

Further the inventive subject matter incorporates a different type of check valve which includes a swing, lift, and wafer check valve.

Further the inventive subject matter incorporates a special forge bonnet (1500 lb to 2000 lb) which has a double top plates.

Further the inventive subject matter incorporates a stand alone stainless steel housing consisted of two compartments which are screwed and stacked on each other and simply inserted inside the two plates and is bolted and sandwiched using the check valve bolts and plates.

Further the inventive subject matter incorporates a top housing contains sensor wires and electronics for flow sensor which is a magnetometer, a thermocouple, and a pressure transducer. Other sensors such as fluid sensor, viscosity sensor, or dielectric sensor, may be added to measure fluid properties such as viscosity, density and fluid make up (such as water cut).

Further the inventive subject matter will have the sensing sections of three sensors penetrate the lower housing. The temperature and pressure sensors will penetrate the check valve and the flow sensor will only rest behind the bottom lower section of lower compartment sensing the magnet attached to the plug or a magnetic plug which moves up and down.

Further the inventive subject matter has six wires belonging to three sensors will exit through a stainless steel one inch pipe from the upper compartment. These wires will be attached to the interface board which converts the analog signals to digital and also will connect the wires to data logger and communication devices of the network. Some of these may be placed in the top section of the stainless steel compartment if desired.

Further the inventive subject matter has a modified lift check valve is used for four different functions: Injection monitoring, production, pump-off controlling, production monitoring, and steam injection monitoring.

Further the inventive subject matter provides in injection monitoring, per flow chart, pressure and time during fluid injection into the reservoir are monitored. We have written codes that an injectivity diagnostic graph can be plotted similar to Hall injectivity plot. Events such as plugging, fracturing, and other information such as radial flow and total skin factor can be alarmed and calculated. The real time trending of Hall Plot and real time calculation of slope will let us do this monitoring. The injection data can help estimating steam quality given flow pressure, temperature and check valve dimensions during injection.

Further the inventive subject matter has In production pump off controlling, the duration of time that check valve stays open during pump plunger upward motion is continuously recorded. As this time decreases, pump off instant is detected and based on the flow chart the pump is turned off.

Further the inventive subject matter has in production condition monitoring plots of flow rate, temperature and pressure versus time are plotted.

Further the inventive subject matter has In steamflood operations specifically a diatomite resource, it is very important to subject the reservoir on many cycles of timely injection and subsequent production. Monitoring of injection and also production via a check valve can help achieve production from a low permeability, high porosity diatomite resource.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. It is intended that changes and modifications can be made to the described embodiment without departing from the true scope and spirit of the subject invention as defined in the claims.

FIG. 1A—is a generalized block diagram of a local supervisory control system.

FIG. 2—is a detailed block diagram of one embodiment of the invention depicting the interrelationship of the local supervisory control system, fluid extraction pumping system and a flow transducer.

FIG. 3—is a detailed block diagram of one embodiment of the invention depicting the interrelationship of the local supervisory control system, fluid extraction pumping system flow transducer and the centralized supervisory control system.

FIG. 4—is a detailed block diagram of one embodiment of the invention depicting a motor controller and programmable time coupled to an electric motor which drives the fluid extraction pumping system.

FIG. 5—is a flow diagram of an embodiment of the invention depicting a process arrangement and the major logic incorporated into the local supervisory control system and centralized supervisory control system.

FIG. 5A—is another flow diagram of an embodiment of the invention depicting a process arrangement and the major logic for providing control signals based on monitored flow signals.

FIG. 6—is a systems and cut-away side view of the system incorporating the sensor check valve.

FIG. 7—is a block diagram of the computer system coupled to the sensor check value.

FIG. 8—is motor controller subsection coupled to the sensor check valve.

FIG. 9—is a cutaway side schematic diagram of the sensor check valve unit.

FIG. 10—is a schematic diagram of stainless steel sensor head mounted on the sensor check valve unit.

FIG. 11—is a flow chart of the operation of the controller incorporating the sensor check valve unit.

FIG. 12—is a flow chart of the operation of the production monitoring, condition monitoring via flow, pressure, and temperature branch of the controller.

FIGS. 13a, 13b—are flow charts of the production monitoring and pump off controlling.

FIG. 14—is a flow chart for the injection monitoring.

### DETAILED DESCRIPTION

This present invention provides an arrangement which utilizes an inexpensive flow transducer and a simple local supervisory control system to monitor and/or control the operation of a positive displacement pump used to extract petroleum from geologic strata. The local supervisory control system controls the operation of an electric motor which drives a reciprocating positive displacement pump so as to maximize the volume of petroleum extracted from the well per pump stroke while minimizing electricity usage and pump-off situations. By reducing the electrical demand and pump-off (i.e., “pounding” or “fluid pound”) occurrences, operating and maintenance costs should be reduced sufficiently to allow petroleum recovery from marginally productive petroleum fields. The local supervisory control system includes one or more applications to at least collect flow signal data generated during operation of the positive displacement pump. No flow, low flow and flow duration are easily evaluated using a flap valve/flow transducer arrangement. The applications are envisioned to be programmed in a high level language such as Java™, C++, C, C#, or Visual Basic™. An example C based program is provided in Appendix 1 to this specification and is herein incorporated by reference. Alternately, applications written for a local supervisory control system may be programmed in assembly language specific to the processor deployed.

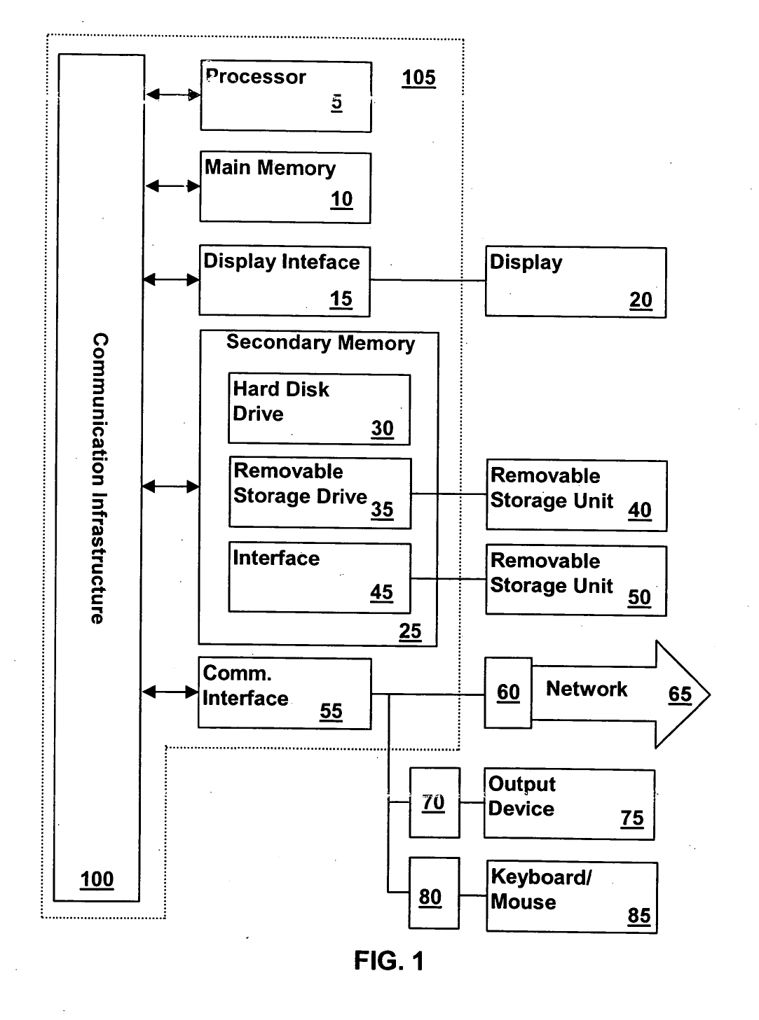

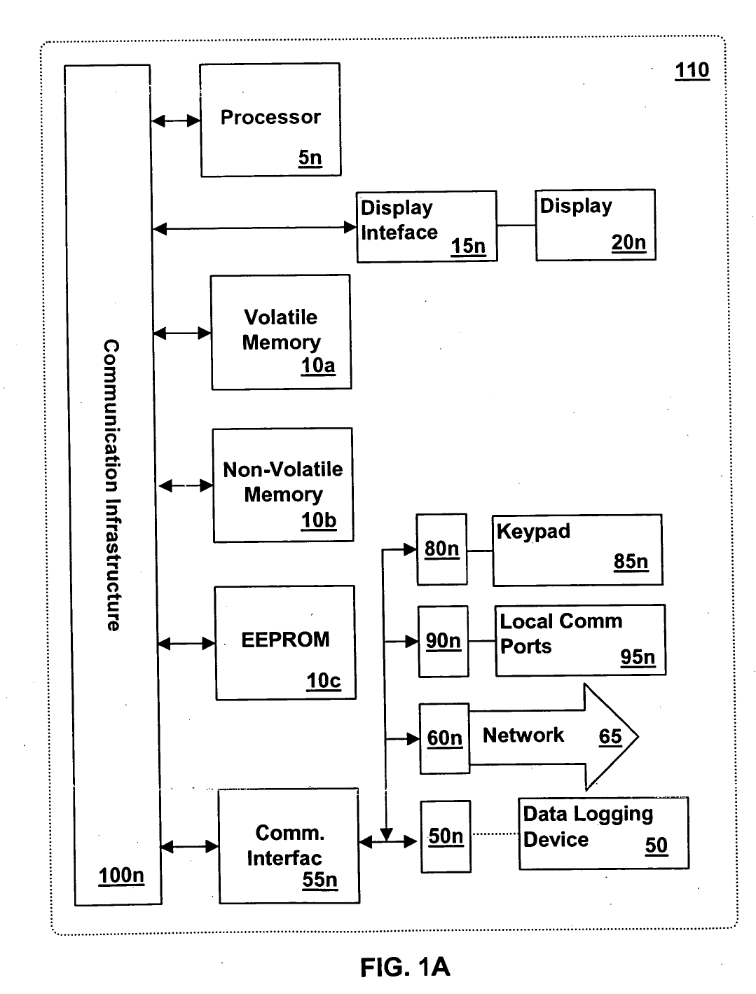

Referring to FIG. 1, a functional block diagram of a centralized supervisory control system 105 is shown which includes a central processor 5, a main memory 10, a display 20 electrically coupled to a display interface 15, a secondary memory subsystem 25 electrically coupled to a hard disk drive 30, a removable storage drive 35 electrically coupled to a removable storage unit 40 and an auxiliary removable storage interface 45 electrically coupled to an auxiliary removable storage unit 50.

A standard desktop, workstation, or laptop may be used as the centralized supervisory control system; however, a computer system arranged in a server configuration may be advisable when large numbers of local supervisory control systems are intended to be centrally managed.

A communications interface 55 subsystem is coupled to a network 65 via a network interface 60. An output device 75 such as a printer or plotter is operatively coupled to the communications interface 55 via an output device interface 70. User input devices such as a mouse and a keyboard 85 are operatively coupled to the communications interface 55 via a user interface 80. The auxiliary removable storage unit 50 may include a data logging device which allows the transfer of accumulated flow data to be collected in the field and downloaded into the centralized supervisory control system for analyses rather than receiving the accumulated flow data over the network 65.

The central processor 5, main memory 10, display interface 15 secondary memory subsystem 25 and communications interface system 55 are electrically coupled to a communications infrastructure 100, commonly known as an I/O bus. The centralized supervisory control system 105 includes an operating system, at least one analytical application for at least receiving and reading flow signal data and generating an output of the flow signal data in a format useful for determining an optimum pumping cycle. Additional capabilities of the application include periodically polling or interrogating a local supervisory control system to retrieve the flow signal data and issue control commands to the local supervisory control system. The analytical application may be a standard spreadsheet type office suite application or a proprietary application written specifically for reading and analyzing the flow signal data.

The network 65 includes wireless networks such as BlueTooth, HomeRF, IEEE 802.11a/b/g and its successors or cellular wireless networks. IEEE 802.20 wired or optical networks may also be employed to communicate with one or more local supervisory control systems addressable over the network 65.

Referring to FIG. 1A, a functional block diagram of the local supervisory control system is shown 110. The local supervisory control system 110 essentially incorporates the same modular components included in the centralized supervisory control system described above but may lack the hard disk drive 30 and display equipment 15n, 20n for power conservation.

The local supervisory control system includes a processor 5n, volatile memory 10a, an optional display 20n electrically coupled to an optional display interface 15n, a non-volatile memory 10b and an electrically erasable programmable read only memory (EEPROM) 10c. The volatile and non-volatile memory 10a, 10b are primarily intended for storage of flow data received from a flow transducer. In addition, the EEPROM 10c is intended to contain a run time operating environment and at least one data acquisition and storage application. Additional control applications may also be installed in the non-volatile memory 10b to generate control signals. One skilled in the art will appreciate that many memory management configurations are possible including the use of programmable read only memory (PROM).

A communications interface 55n subsystem is coupled to the network 65 via a network interface 60n, a data logging device 50 is coupled to coupled to a data logging interface 50n and a user interface arrangement 85n is coupled to a user device interface 80n and one or more local communications ports 95n are coupled to a communications port interface 90n. The processor 5n, volatile memory 10a, optional display interface 15n, non-volatile memory 10b, EEPROM (or PROM) 10c and communications interface system 55n are electrically coupled to a communications infrastructure 100n.

The local communications ports 95n includes standardized serial communications protocols such as RS-232, RS422, RS423, RS485, or USB. Alternately current loop (4-20 mA) arrangements with an analog to digital (A/D) converter will work as well.

The local communications ports 95n are intended to interface with a flow transducer and optionally a motor controller and/or programmable timer associated with an electric motor which drives a positive displacement pump.

The local supervisory control system 110 further includes an operating system either loaded into the EEPROM 10c or at least a portion of the non-volatile memory 10b along with at least one data acquisition and storage application and one or more communications applications. Optionally control applications may be installed to generate and send control signals to the motor controller and/or programmable timer.

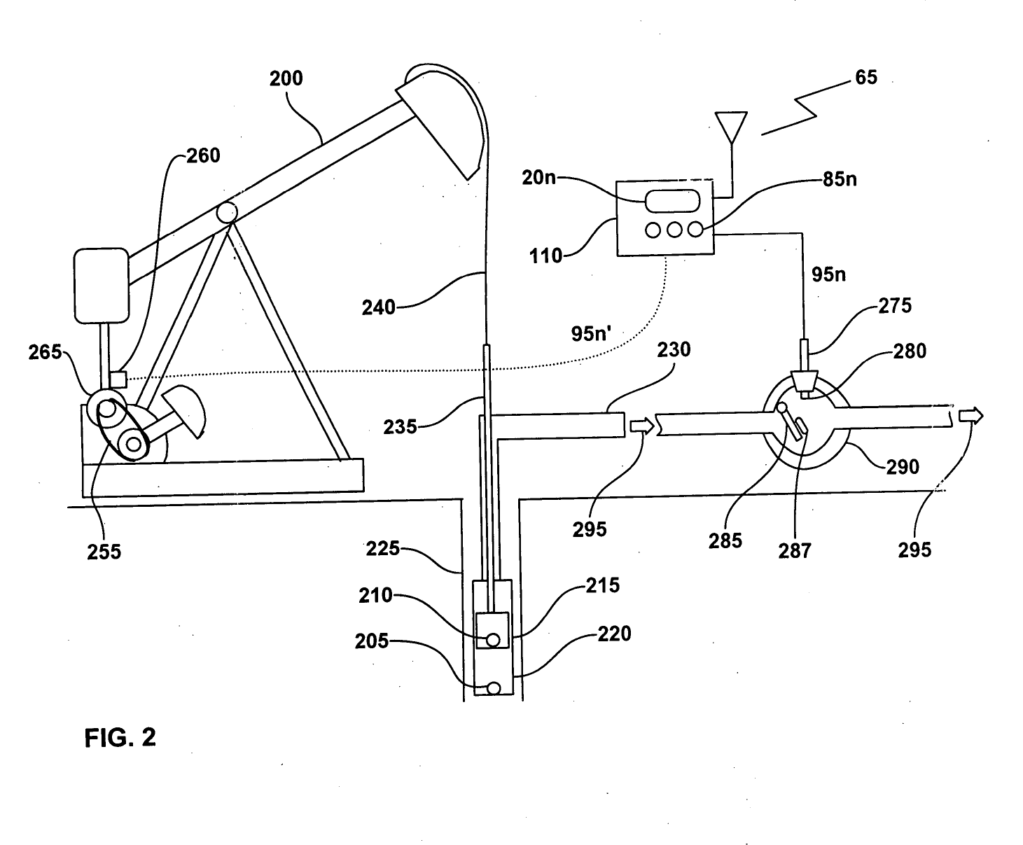

Referring to FIG. 2, an example arrangement is depicted where extraction of petroleum from the well 225 is being accomplished using a walking beam type pumping unit 200. This type of pumping unit is typically driven by an electric motor 265. The electric motor 265 is coupled to a motor controller 260 or motor control center which controls the operation of the electric motor 265 and hence that of the pump 200.

The electric motor 265 turns a drive belt assembly 255 which causes the walking beam portion of the pumping unit to rise and fall around a pivot point. On a pump upstroke, a traveling valve 210 is closed and the weight of the petroleum fluid in a capture volume 215 is supported by a cable 240 (sucker rod string), allowing fluid to enter a pump barrel 220 through a standing valve 205. On a downstroke, the petroleum fluid in the pump barrel 220 forces traveling valve 210 to open, transferring the fluid load from the cable 240 to the discharge conduit 230.

The discharge of petroleum fluid flows 295 through the discharge conduit 230 and through a flap valve 290. The flap valve 290 is installed in line with the discharge conduit 230 of the downhole pump 230. A flow transducer 275 is coupled to the flap valve 290 which detects movements of an internal flap element 285 caused by the flow of petroleum 295 through the flap valve assembly 290.

The flap valve 290 is usually pre-existing in the discharge conduit 230 and is used as a check valve to prevent the backflow of the extracted fluid 295. As such, only a simple modification is required to be made to the existing flap valve 290. In one embodiment of the invention, the flap element 285 includes or is modified (pre-existing flap valves) to include at least one permanent magnet 287 or an equivalent flow signal generating arrangement. Examples of other acceptable methods of detecting movement of the flap element 285 include variable reluctance effects, Hall effects, magnetic inductance effects, binary switch states (using a reed switch), variable voltage or current (using a potentiometer) flows or piezoelectric effects. In the magnetic embodiment of the invention, movement of the flap element 285 induces a current flow, voltage flow or magnetic field in a sensing element portion 280 of the transducer 275.

The actual detection mechanism employed will likely depend on cost considerations, accessibility of existing check valves, and ability to performance maintenance on the flap valve 290, flap element 285 and flow transducer 275 and sensing element 280. In existing installations, the valve core including the flap element 285 is removed from the valve body 290 and one or more permanent magnets 287 are affixed to the flap element 285. The magnet(s) may be affixed using common fasteners and/or a permanent adhesive (e.g., self-threading bolts, rivets, nut and bolt arrangements or an epoxy adhesive). Alternately, a simple metal bracket having the permanent magnet(s) affixed with a permanent adhesive may then be attached to the flap element 285 using one or more of the fasteners.

In new installations, the construction of the flap element 285 may be of a low cost material compatible with the petroleum fluid and associated vapors such as polyvinyl chloride (PVC), other compatible synthetic polymeric materials or corrosion resistant metal alloys. An example of a flap valve having a suitable flow transducer for use in this invention is described in U.S. Pat. No. 5,236,011 to Casada, et al.

Movement of the flap element 285 causes a flow signal to be transmitted over a communications link 95n to the local supervisory control system 110. The communications link may employ electrical, optical or wireless technologies; however, cost considerations may favor a wireless arrangement such as BlueTooth.

Depending on the type of flow transducer 275 employed, an A/D converter and a line transmitter may be required to communicate with the local supervisory control system 110. A delay circuit or logic may also be included to allow sufficient fluid flow to be generated during pump startup. The flow signals generated by the transducer 275 are accumulated in the memory of the local supervisory control system 110. In one embodiment of the invention, the accumulated flow signals are transferred to a centralized supervisory control system over a telecommunications network 65.

Transferring of the accumulated flow signals may occur automatically based at least in part on time, in response to a transfer request issued by the centralized supervisory control system 105 or in response to an event including flow based events, detected error conditions or coupling of the data logging device to the local supervisory control system 110. The data logging device may include a dedicated data logger, a laptop computer, a personal data assistant (PDA), or a PDA equipped cellular telephone adapted to communicate with the centralized supervisory control system 110.

In another embodiment of the invention, the local supervisory control system 110 is coupled to the motor controller 260 by way of another communications link 95n′. In this embodiment of the invention, the local supervisory control system 110 both monitors and accumulates the flow signals sent from the flow transducer 275 and includes logic to send control signals to the motor controller 260 as is shown in Table 1 below. One skilled in the art will appreciate that other logic arrangements may be employed as well.

TABLE 1

A task/state model algorithm is employed; tasks are intended to be executed

simultaneously through time slicing, cooperative multitasking or interrupts; each task is
assumed to be in one state at any given time. Variables are shown as
[description].Conditional expressions are shown as (thus).

| | |
|---|---|
| TASK 1: | SENSOR POLLING |

State 0 - Initialize if (valve closed)

Transition to valve closed state

State 1 - Valve closed

if (valve open signal detected)
save [time at which opening detected] transition to valve open state

State 2 - Valve open

if (valve closed signal detected)
save [time at which closing detected] compute duration of time valve was open

add time to [total duration of open time]

else if (maximum valve open time exceeded) set stuck valve error flag
TASK 2: COMPUTATION OF FLOW AMOUNT

State 0 - Initialize

set [total duration of open time] to zero (always) transition to

waiting/pump on state

State 1 - Waiting/Pump On

if (inactive period elapsed)
if ([total duration of open time] < limit) set [total duration of open time] to zero

turn pump off record time of pump turning off transition to pump off state

if (maximum pump on time elapsed) set [total duration of open time] to zero turn

pump off record time of pump turning off transition to pump off state

State 2 Pump Off

if (preset pump off time exceeded) turn pump on record time of pump turning on

transition to waiting/pump on state

TASK 3: COMMUNICATION

State 0 - Initialize

set [percent of time open] array elements to zero (always) transition to wait for

transmit time state

State 1 - Wait for Recording Time
if (error condition detected) transmit error code immediately
if (wait time elapsed) compute new value of percent time valve open transition to

recording/transmitting state.

State 2 - Recording/Transmitting

save [percent of time open] in array
if (time between data transmissions elapsed) transmit ID and header information

transmit data from array of percent times open transmit data from array of pump on/off
data transmit end of data signal and checksum(s)

(always) transition to wait for recording time state.

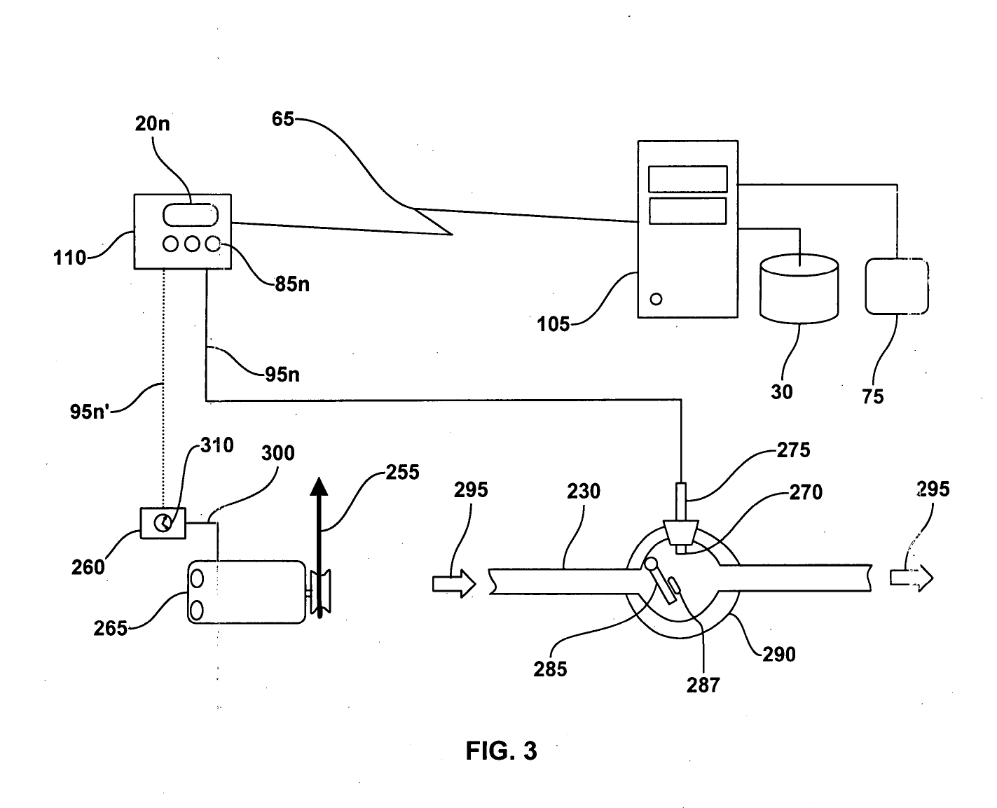

Referring to FIG. 3, another embodiment of the invention is depicted where the local supervisory control system 110 is in processing communications over a telecommunications network 65 with a centralized supervisory control system 105. In this embodiment of the invention, the centralized supervisory control system 105 periodically polls and/or interrogates the local supervisory control system 110 for accumulated flow signal data obtained from the flow transducer 275. The centralized supervisory control system 105 may also include the ability to determine an optimum pumping cycle in which the motor controller 260 should be operated to maximize petroleum withdrawal from the well 225 shown in FIG. 1, minimize electrical power usage of the electric motor 265, minimize wear and tear on the well pump and drive system 255 and reduce well pump-off. At least one analytical application is provided for receiving and reading flow signal data and generating an output in a format useful for determining an optimum pumping cycle. The analytical application may be a standard spreadsheet type office suite application or a proprietary application written specifically for reading and analyzing the flow signal data. Alternately, the optimum pumping cycle may be determined by an operator after reviewing the accumulated flow signal data.

In one embodiment of the invention, the local supervisory control system 110 includes a telecommunications link 95n′ with the motor controller 260 and/or a programmable timer 310 coupled to the motor controller 260. In this embodiment of the invention, an optimized pumping cycle is generated by the centralized supervisory control system 105, sent over the network 65 to the local supervisory control system 110 and downloaded over the telecommunications link 95n′ to the motor controller 260 and/or a programmable timer 310.

An equivalent automated programming of other motor controllers and/or programmable timers is envisioned using other local supervisory control systems in processing communications over the network 65 with the centralized supervisory control system 105. In another embodiment of the invention, the centralized supervisory control system 105 determines an optimized pumping cycle and provides and output on an output device 75 such as a printer or plotter. The output is then used by an operator to manually program the motor controller 260 and/or a programmable timer 310. In an embodiment of the invention, control commands can be sent from the centralized supervisory control system 105 to the local supervisory control system 110 to upload or transfer the accumulated flow signals or to turn the associated positive displacement pump on or off. The control commands may be issued periodically (time based) or in response to a flow based event or detected error state.

Lastly, the centralized supervisory control system 105 is further provided with a data store 30 for maintaining and archiving of flow signal data received from one or more local supervisory controllers over the network or by way of data logging device downloading. The data store 30 is envisioned as a database or parseable file.

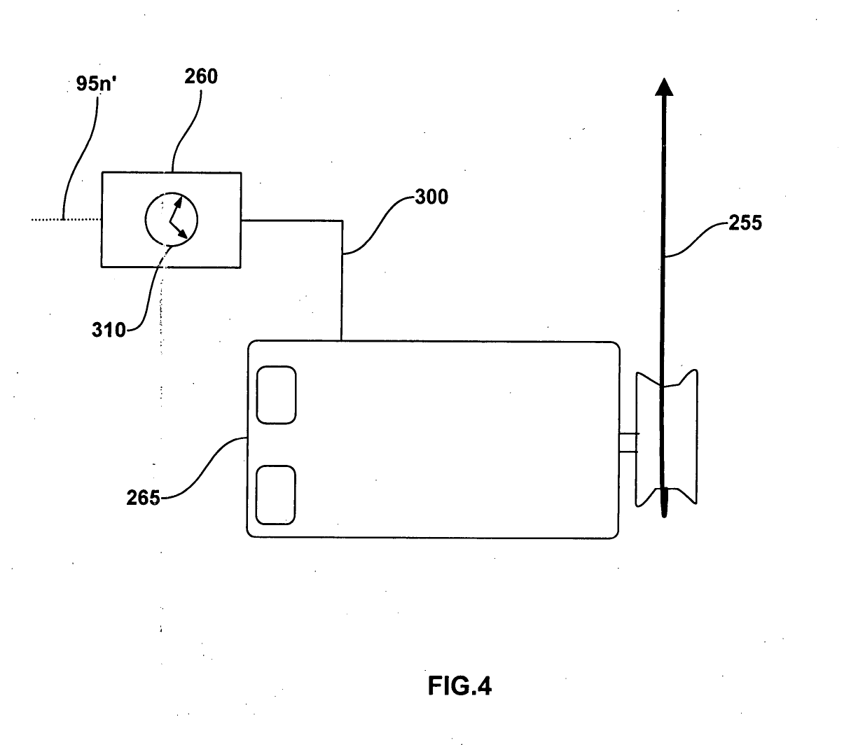

Referring to FIG. 4, a more detailed view of the motor controller 260 and programmable timer 310 is provided. In one embodiment of the invention, the motor controller and/or programmable timer are coupled to the local supervisory control system via the telecommunications link 95n′. In another embodiment of the invention, the motor controller and/or programmable timer are manually programmed by the operator based on the output obtained from the centralized supervisory control system.

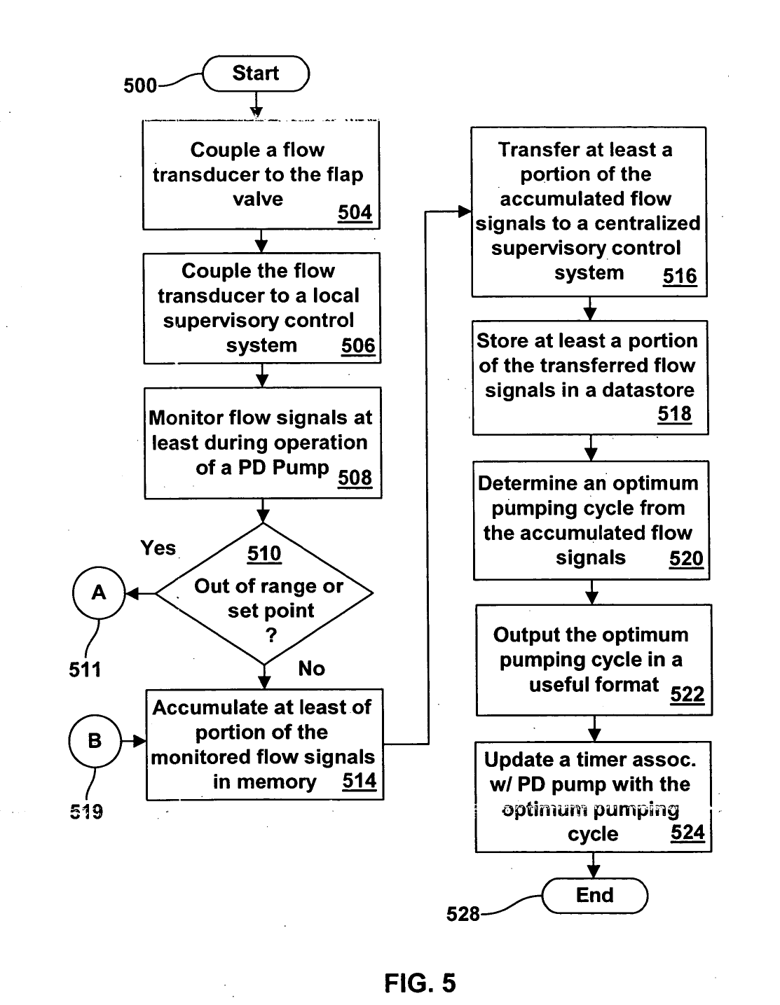

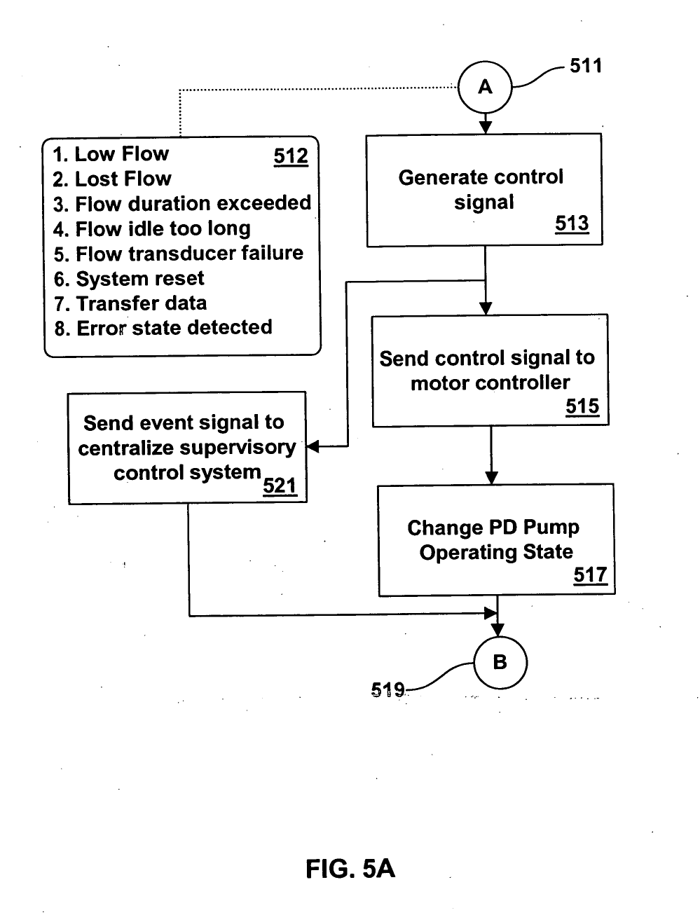

Referring to FIG. 5, a flow chart is provided which illustrates the major process arrangements implemented by the various embodiments of the invention. The process is initiated 500 by the installation or modification of an existing flap valve inline with the discharge conduit associated with a positive displacement pump installed on a petroleum recovery well. A flow transducer which is adapted to sense movement of a flap element internal to the flap valve is then coupled to the flap valve 504. The flow transducer is then electromagnetically coupled to a local supervisory control system 506 which monitors the flow signals generated by the flow transducer at least during operation of the positive displacement pump 508.

The local supervisory control system determines if one or more of the flow signals are out of range or exceed a set point 510. If one or more monitored flow signals are out of range or exceed a set point 510, a control sequence 511 is initiated as described in the discussion for FIG. 5A. If no flow signals are out of range or exceed a set point 510, at least a portion of the monitored flow signals are accumulated in a memory of the local supervisory control system 514. When requested or periodically, at least a portion of the accumulated flow signals are transferred to the centralized the centralized supervisory control system 516 where at least a portion of the transferred flow signals are stored in a data store 518 such as a database or parseable file.

The centralized supervisory control system then determines an optimum pumping cycle from the accumulated flow signals 520 and provides an output in a useful form for operating the positive displacement pump 522. The output is then used to update a timer associated with positive displacement pump 524. The process ends until another optimized pumping cycle is determined 528.

Referring to FIG. 5A, if one or more monitored flow signals are out of range or exceed a set point, a control sequence is initiated 511. The control sequence may be initiated due to a low or lost flow condition, flow duration exceeded, flow idle too long, flow transducer failure, system reset, transfer command received, or an error state detected 512. A control signal is then generated 513 and sent to at least a motor controller 515. The motor controller then causes a change in the operating state of the positive displacement pump. The process continues to accumulate at least a portion of the monitored flow signals in memory 519 as is provided in the discussion for FIG. 5. In another embodiment of the invention, one or more event signals are also sent to the centralized supervisory control system for logging, operator interaction and archival purposes 521.

Pressure, Flow, and Temperature Check Valve Improvements

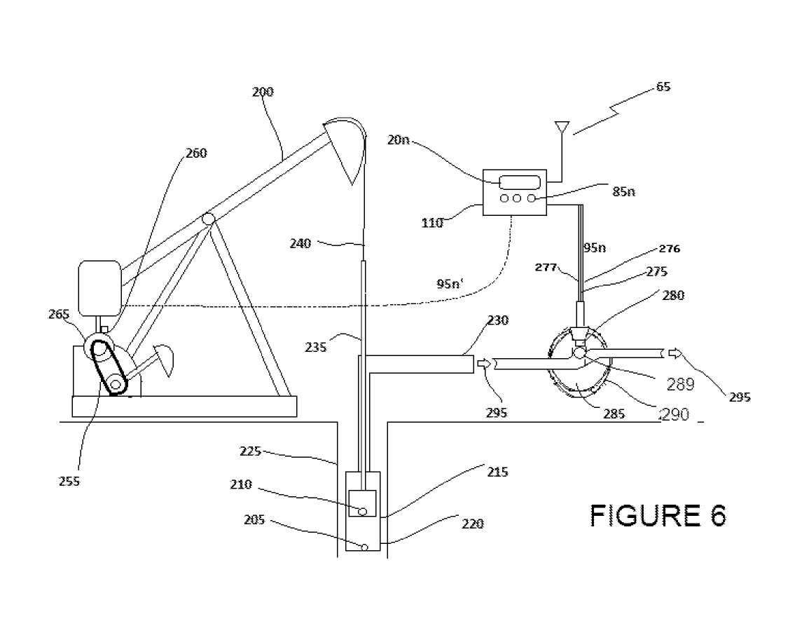

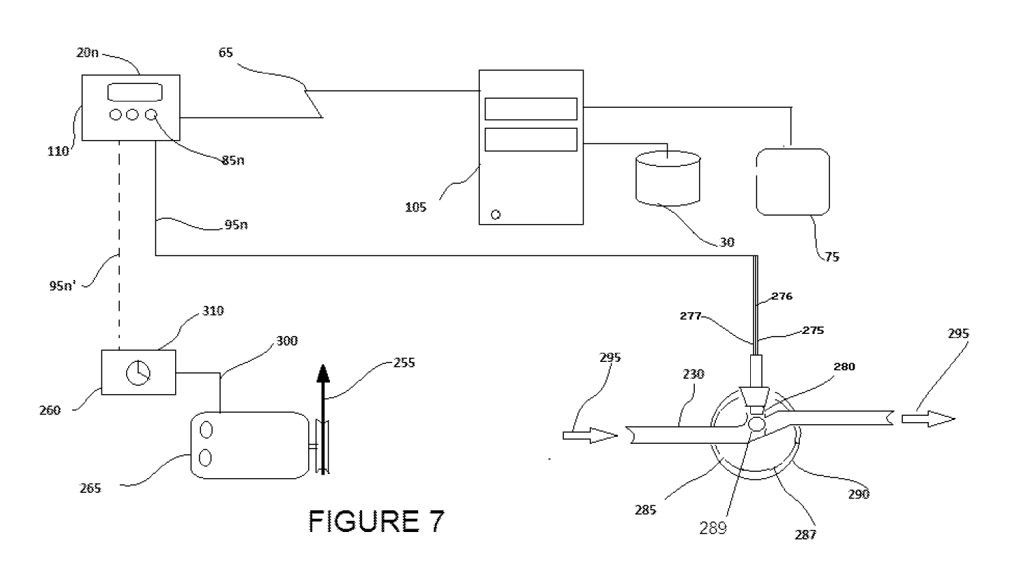

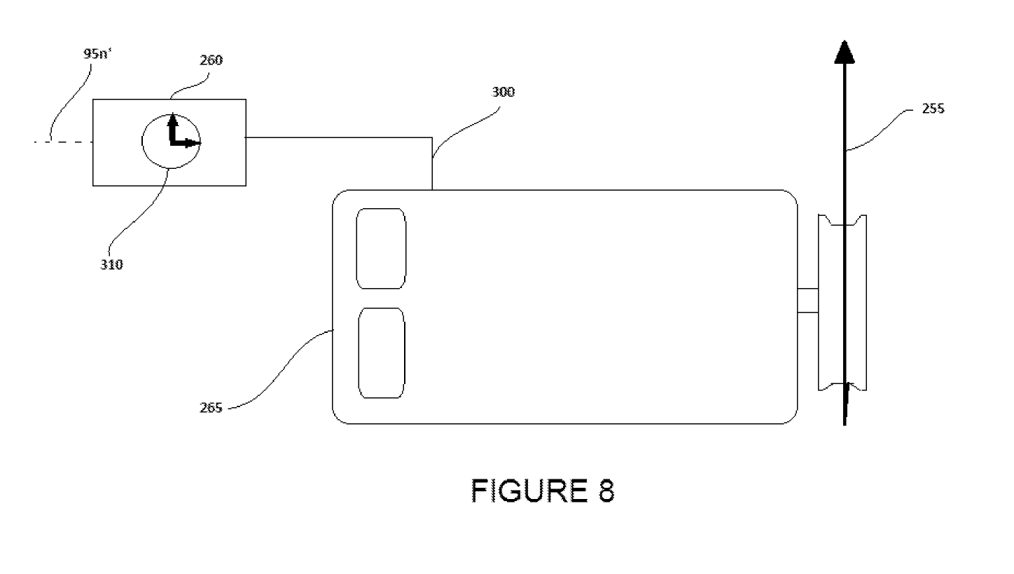

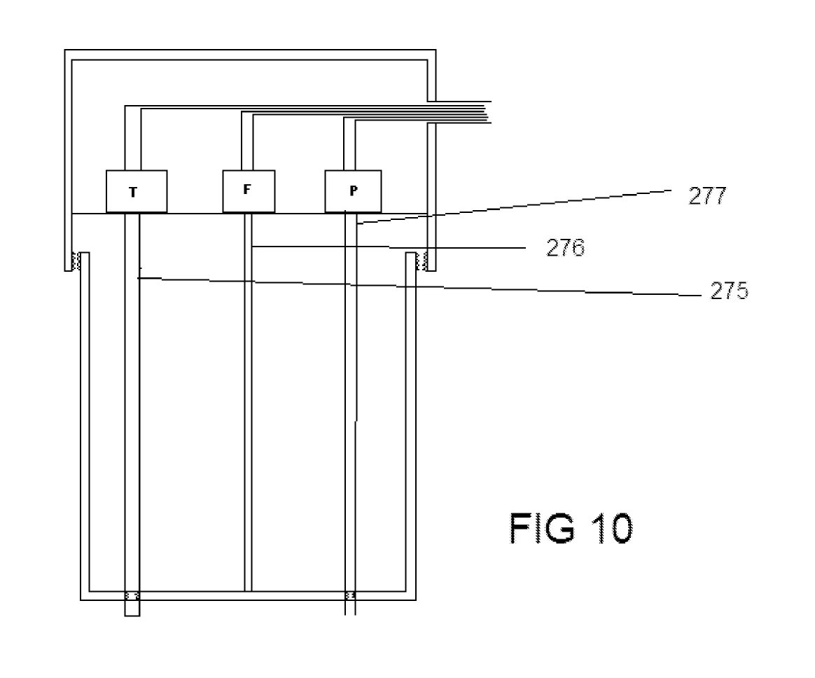

This embodiment is depicted in FIGS. 6-14. This embodiment relates to the improved condition for monitoring and control that is provided from different sources for the purpose of harmonizing petroleum production. This embodiment is better suited in a more challenging production environment including control and monitoring when gas is present with the liquid and much more. It also brings about more benefits to the operators in the oil and gas industry.

Now referring to FIG. 6 which depicts a generalized systems diagram of the improved embodiment of the pumping control systems as depicted in FIG. 1a-5b, but previous “flapper style” check valve is replaced with a sensor check valve 289. The sensor check valve 289 is located in line with the discharge conduit 230.

The sensor check valve 289 is constructed from double disk plates. The stainless steel sensor head which is put between the two plates has two compartments. The lower and upper compartments are screwed together. The lower compartment incorporates temperature, pressure and flow sensors. Other sensors such as fluid, viscosity and dielectric sensors may also be included to measure fluid density, viscosity and makeup. Only the temperature and pressure will penetrate the top space of the check valve. The flow sensor is magnetic and will not penetrate the check valve. The flow sensor will sense movement of the magnetic valve plug. The upper compartment will house the signal conditioning electronics.

The sensor check valve 289 has a magnet is attached to the lift pig or the pig is made out of magnet inside the sensor check valve. During operation, the sensor check valve incorporates a displacement of the lift pig, and simultaneously the fluid temperature, closing, and opening of the check valve are also monitored.

There are three operational cases for the sensor check valve 289. The first operational case is where there is non-continuous flow, and the valve is open 100%. Flow is calculated from subtraction of no flow sequences from the total flow.

In the second operational case there is a non-continuous flow, with the valve opened partially. During operation, a graph of oil flow rate as a function of time is similar to a sine wave; the volume of flow during non-continuous flow is calculated by integrating the area under the curve of the recorded “sine wave” from the graph. This flow number, or volume of the flow is generated by integrating the area under the curve.

In the third operational case, there is continuous flow and the valve is 100% open. The flow number is then calculated from well-known analytical formulas described in the literature. Likewise, the flow number can be calculated by calibration of similar system in the lab.

There also exist other embodiments that allow for the detection of the lift pig movements. In one embodiment, a series of LCD lights and Hall Effect sensors are placed along the stainless steel pipe. As the inside magnet attached to the lift pig plunger inside the stainless steel pipe goes up and down, lights will turn off and on showing exact position of the plunger and valve opening.

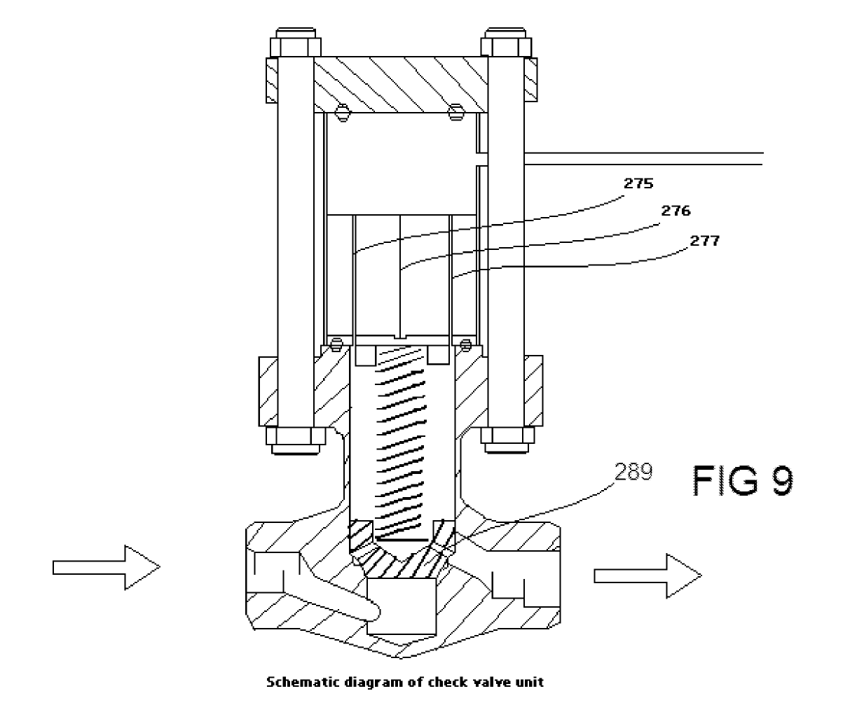

FIG. 9, shows a cut-away view of a valve unit that has pressure, temperature, and flow sensors. The sensor check valves 289 may be modified per drawings submitted. The sensor check valve 289 may be used in injection, production flow monitoring. The injection can include water, steam, and other gases. The process of modification of the sensor check value includes coupling to a flow sensor.

The processing of data from the flow sensor includes the following steps:
1—Method one—this is based on counting of opening occurrence of the check valve via software at valve.
2—Method two—this is based on detecting position of the check valve by a magnetometer.
3—Method three—this is based on placement of a Hall Effect sensor to track position of check valve.
4—Method four—this is based on measurement of pressure drop across check valve.
5—Method five—this is based on correlation to speed of sound. Two sound transmitter and receivers are put at 45 degrees on the vertical stem of the valve. Since flow is upward, sound transient time in the direction and opposite in direction to flow is correlated to flow.

The sensor check valve can be placed at locations where many individual pipes from individual wells come to one common point known as header. In this case, smart check valves can use one single data logger and one single broadcasting station which lower the cost of monitoring. Three sets of data streaming from these headers can be placed on electronic maps which are available today. GPS system can provide coordinates of these headers. The information can also be put on handheld receiver units.

The sensor check valve are used in single point or multi-point installations It is capable of integrating the well headers that have from 5 to 15 pipes that come together for rate measurement. Separators are used to put wells into flow measurement for 24 hours which is very time consuming and labor intensive. Smart check valve installations can provide much savings.

Now again referring to FIG. 9. The sensor check valves installed at the headers are modified to accommodate temperature 275, pressure 276, and flow rate 277 sensors. The temperature sensor 275 is a thermocouple calibrated to give analog mili-volts versus temperature values. The pressure sensor 276 is a pressure transducer to give analog mili-volts versus pressure values. The flow rate sensor 277, a flow transducer, is providing analog mili-volt values, reporting on position of the check valve, or also by measuring pressure drop across the check valve. The flow rate sensor 277 is calibrated against different flow rates prior to installation with the calibration curve being a plot of flow rate versus mili-volt for different flow rates.

The sensor check valve interface can be either wire, or wireless, communicating with one single data logger put on the side of the header. In one embodiment the wires are encapsulated in a sealed flat bed for protections against weather effects.

To collect data from the sensor check valve the following methods may be used:
a) The data logger will convert analog signals to digital so they can be polled by the radio Ethernet, cell network or a satellite link.
b) Prepare the temperature, pressure, and flow data and let them to be downloaded via Google map into a hand-held device known as “Well Navigator”. Well coordinates can be obtained for each well via GPS published data.
c) Monitor the pump flow rate in any desired interval. If there is no flow reported, send a return command

The method for determining optimal pumping cycle includes reviewing the data from the sensor check valve 289 and turning the site pump switch to turn off the pump for a desired amount of time.
a) If the calculated trend of the flow rate and or pump displacement efficiency are in a decreasing order, the operator may send a return command to the electronics install for variable speed drive to slow the pump down, lower stoke per minute, so the pump does not pump off.
b) If the pump calculated flow rate and or the pump displacement efficiency are on an increasing order, the operator may decide to make no changes provided that as long as the pump is not pulling too hard.

The system provides plenty of benefits, such as:
a) Events including no flow can be alarmed so the pump is turned off.
b) Events such as reducing flow could be signaled to the pump variable speed controller to step down into lower strokes per minute or stay constant. This is important for optimizing steamflood operations specifically for diatomite formation so effects of pulses of heat could be studied in short interval of time.
c) The pressure data can be used to detect leak in pipelines.
d) The pressure data can also be used in future design of check valves
e) The pressure data can also be used to detect and possibly reverse flow into the valve.

Rod pump installation needs to have a check valve near the wellbore and elsewhere where fluids including gas, oil and water are continuously produced in oil and gas wells. The check valve is placed in order to prevent fluids from returning to the pump and enhancing the pumping process.

This system monitors flow across different check valves; have related the pressure drop across the check valve or valve opening, or numbers of the valve opening, to flow rate across the check valve. The magnetic sensor monitors the up and down or swinging motion of the check valve, to determine pump flow rate and pump displacement efficiency and if the pump is pumping off due to lack of the fluid in the wellbore. With pumps that consume electricity, a dependable variable controller that turns the pumps off, slow them down, and/or speeds them up will an optimize the inflow-outflow performance. “Inflow” is referred to fluid movement from the geological strata to the sandface at the bottom of the well. “Outflow” is referred to fluid movement from the bottom of the well, wellbore flow, to the surface facilities ending at the oil, water, gas separator. The sensor check valve design is a low cost but effective pump variable speed controller.

As shown in FIG. 6, the sensor check valve 289 described here is considering placement of three sensors at the check valve. The sensors proposed are magnetic, temperature and pressure sensors to measure and report check valve displacement, temperature and pressure of the cavity exists on top of the check valve under the valve top plate where the check valve motion is taking place. We can do this because of the advances took place in sensor technology at a favorable costs. As the flow, temperature and pressure data from the check valve arrive in the central computer miles away wirelessly via radio mesh networks, internet, etc., the central unit now can make better decisions to turn the pump off, slow pumping speed, or increase pumping speed to maintain optimum performance:

Advantages of the sensor check valve 289 include:
1—Placement of pressure and temperature and magnetic sensors at check valve can make the decision making process accurate.
2—In case of liquid flow only, since gas is separated downhole, the temperature and pressure should follow a decreasing trend as the liquid flow rate decreases to zero. Pressure and temperature will change as flow changes.
3—The temperature data could also provide additional information in the case of steamflooding of the field. This can help the operator in management of the heat and making sure all sections of the reservoir show an increase in temperature which is essential in steamflooding operations.
4—The pressure sensor could provide added benefits in detecting any leaks or plugging, before and after the valve. This can provide better responses for possible leaks which lead to oil spills. It also can alarm possible pipe plugging by paraffin, asphaltenes and hydrates.
5—The same design is also recommended in flow monitoring and control of gas wells.
6—The same design could also help flow signatures in an oilfield. This may help selections of production and injection wells for optimum petroleum recovery by shutting low performer wells in a network of wells.
7—For an optimum pumping performance, all pumps should have a variable speed controller so the pump delays getting into pump off conditions due to inflow performance of the reservoir delivering fluids into the well. In the events of no flow recorded across the check valve the pump will be turned off so inflow performance of the reservoir to take over and deliver fluids to the well. In the case of reporting decreasing flow events, variable controller can lower the pump stroke per minute so the pump suction can keep up with the inflow performance governed by the reservoir. As the flow stabilizes then the variable controller can speed up the pump. This invention is very important because for the first time possibility of manufacturing and marketing a rod pump which does not pump off as often becomes possible. The additional redundancies of T and P sensors will help calculations of flow more accurate.

The sensor check valve 289 related to these different condition monitoring and control can be improved by providing more information from different sources for the purpose of harmonized production. The sensor technology has progressed a great deal and fortunately their costs have reached favorable levels to propose some redundancy of sensor installation in order to get a more accurate and universal system. The proposed design then can perform much better in a more challenging environment including control and monitoring when gas is present with the liquid and much more. It also brings about more benefits to the operators in the oil and gas industry due to huge cost savings. Here is a list of these claims:

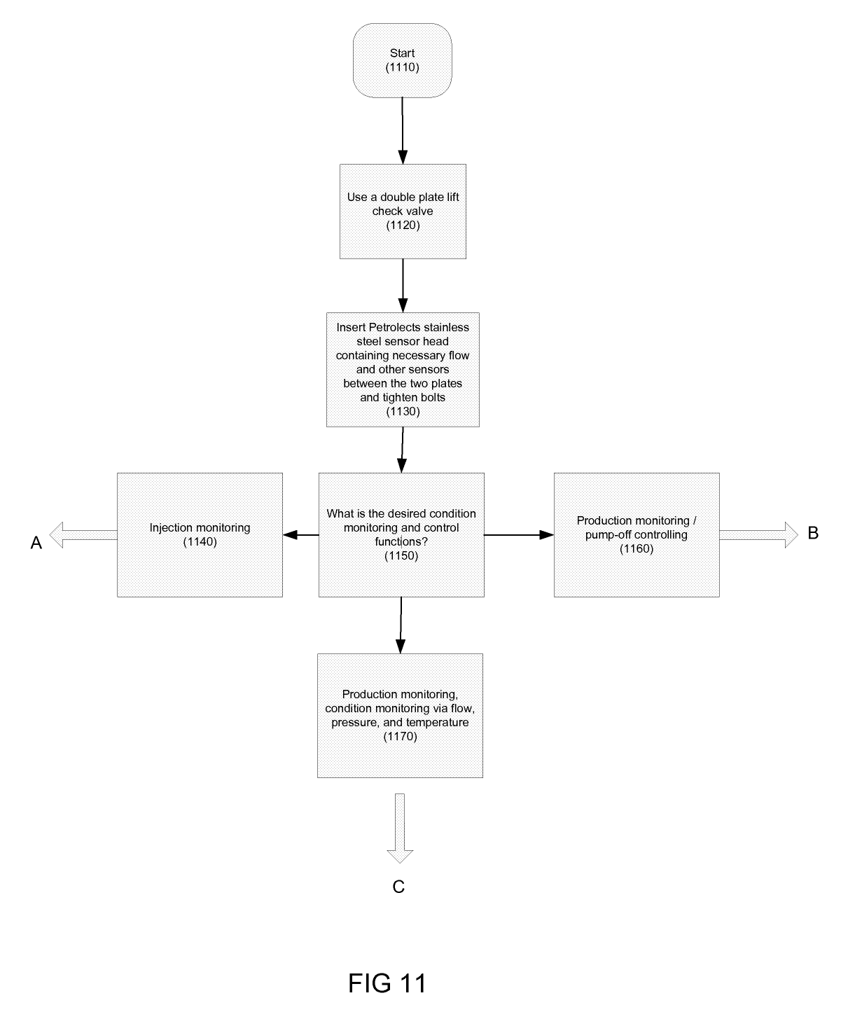

Now referring to FIG. 11 which is a flow chart of the operation of the controller incorporating the sensor check valve unit. To implement the production control system using the sensor check valve 289 requires that the double plate lift check valve (1120) is removed and the sensor head is inserted between the two plates and tighten bolts on the lift check valve (1130). The desired condition monitoring and control functions (1150) are selected from three operating modes: a) injection monitoring (1140); production monitoring/pump-off controlling (1160); and c) production monitoring, condition monitoring via flow, pressure, and temperature (1170).

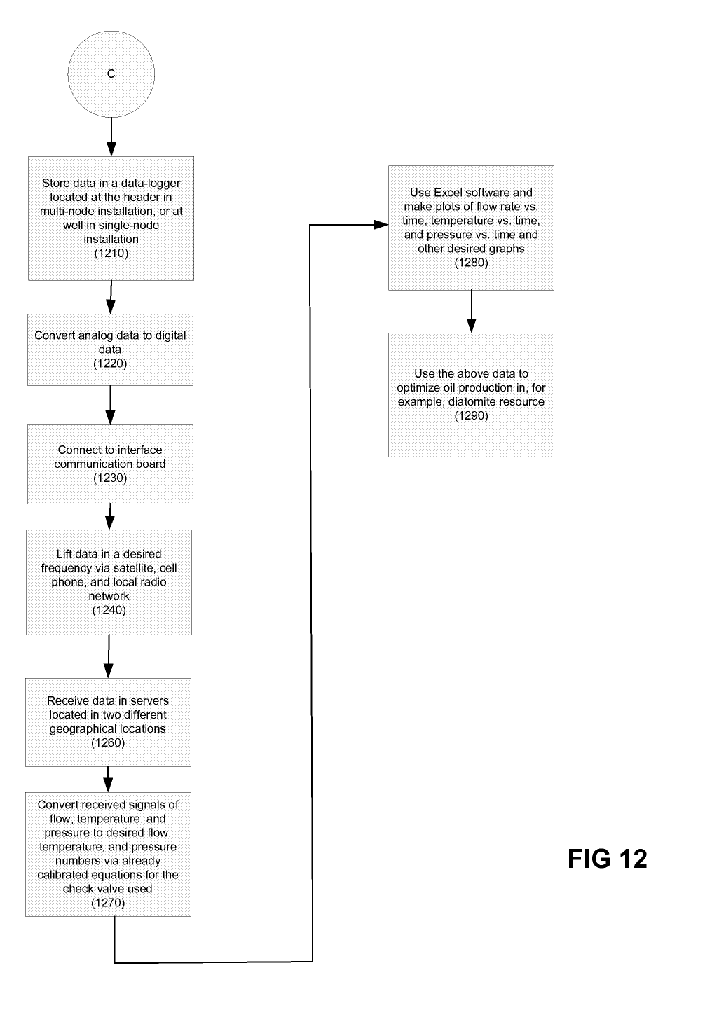

Now referring to FIG. 12 which details the steps needed for production monitoring, condition monitoring via flow, pressure and temperature (1170). Store data in a data-logger located at the header in multi-node installation, or at a well in single-node installation (1210). Convert analog data to digital data (1220) Connect to interface communication board (1230). Transmit lift data in a desired frequency via satellite, cell phone, and local radio network (1240). Receive data in servers located in two different geographical locations (1260). Convert received signals of flow, temperature, and pressure to desired flow, temperature, and pressure numbers via already-calibrated equations for the check valve installed (1270). Use spreadsheet software to make plots of flow rate vs. time, temperature vs. time, and pressure vs. time and other desired graphs (1280). Use the above data to optimize oil production in, for example, a diatomite resource (1290)

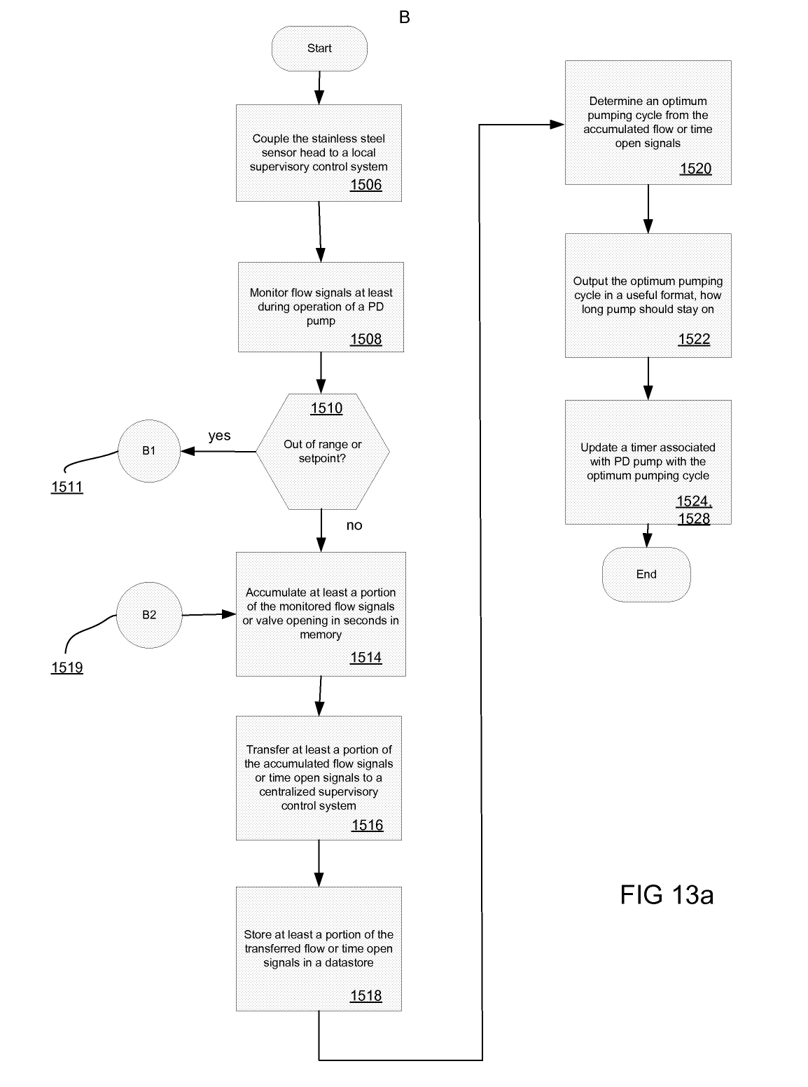

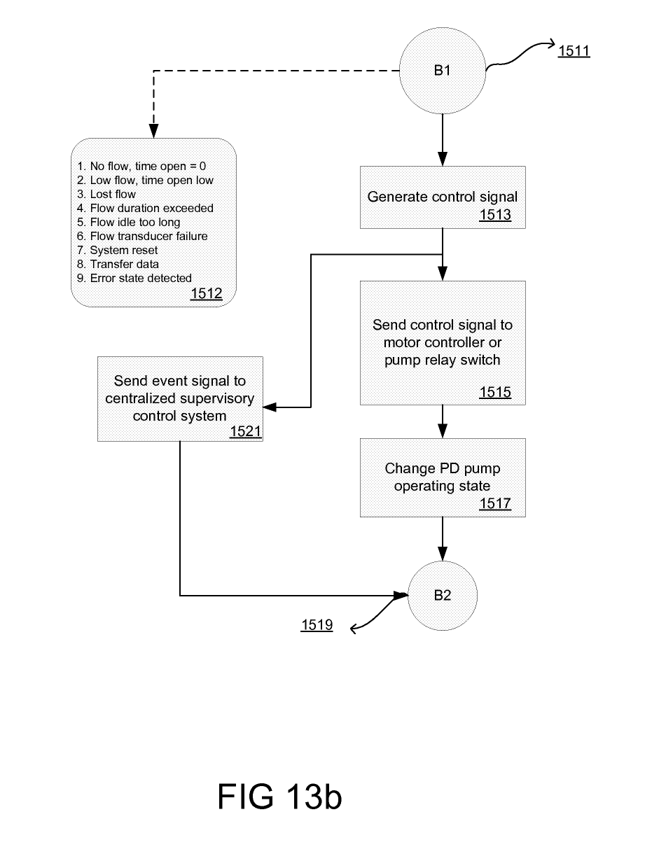

Now referring to FIGS. 13a, 13b which are flow charts of the production monitoring and pump off controlling. Referring to FIG. 13a, the first step is to couple the stainless steel sensor head to a local supervisory control system. (1506). Monitor flow signals at least during operation of a PD pump (1508) Accumulate at least a portion of the monitored flow signals or valve opening in seconds in memory (1514). Out of range or setpoint? (B1) (1511) Transfer at least a portion of the accumulated flow signals or time open signals to a centralized supervisory control system (1516). Store at least a portion of the transferred flow or time open signals in a datastore (1518). Determine an optimum pumping cycle from the accumulated flow or time open signals (1520). Output the optimum pumping cycle in a useful format, how long pump should stay on (1522). Update a timer associated with PD pump with the optimum pumping cycle (1524, 1528).

Now referring to FIG. 13b which describes the operational states of the sensor check valve: 1. No flow, time open=0 2. Low flow, time open low 3. Lost flow 4. Flow duration exceeded 5. Flow idle too long 6. Flow transducer failure 7. System reset 8. Transfer data 9. Error state detected. The generate control signal (1513), the send event signal to centralized supervisory control system (1521), the send control signal to motor controller or pump relay switch (1515); the change PD pump operating state (1517); and the send event signal to centralized supervisory control system. (1519).

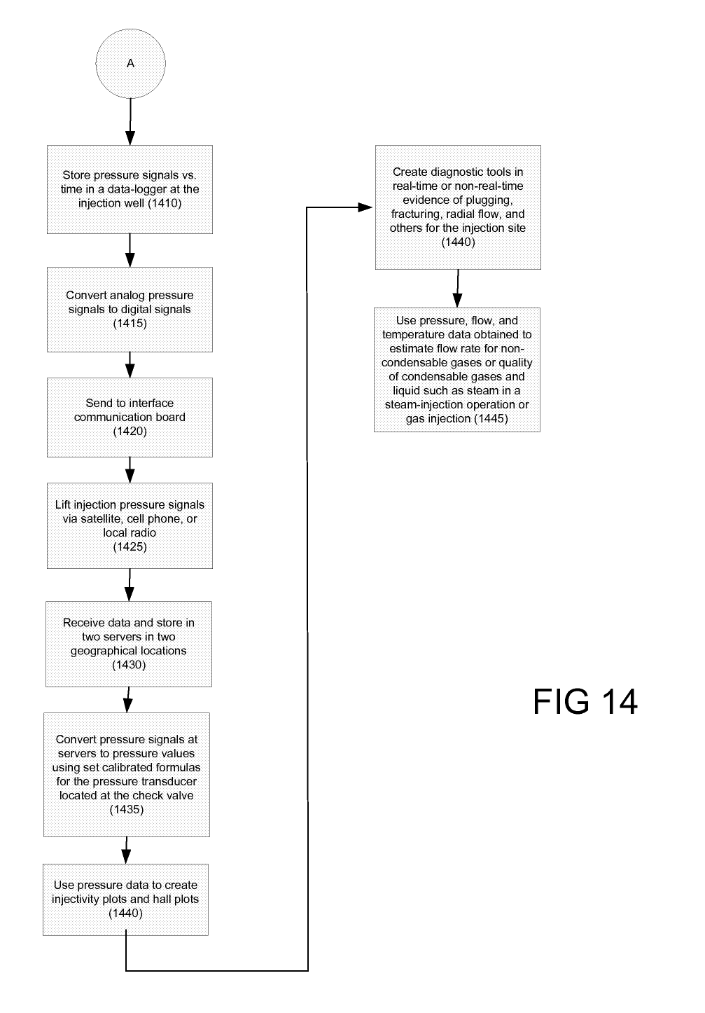

Now referring to FIG. 14 which describes the process flow for injection monitoring. First the measure and store pressure signals vs. time in a data-logger at the injection well (1410). Then convert analog pressure signals to digital signals (1415). Send to interface communication board (1420) Lift injection pressure signals via satellite, cell phone, or local radio (1425). Receive data and store in two servers in two geographical locations (1430). Convert pressure signals at servers to pressure values using set calibrated formulas for the pressure transducer located at the check valve (1435). Use pressure data to create injectivity plots and hall plots (1440). Create diagnostic tools in real-time or non-real-time evidence of plugging, fracturing, radial flow, and others for the injection site (1440). Use pressure, flow, and temperature data obtained to estimate flow rate for noncondensable gases or quality of condensable gases and liquid such as steam in a steam-injection operation or gas injection (1445)

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. No specific limitation is intended to a particular operating environment. Other variations and embodiments are possible in light of above teachings, and it is not intended that this Detailed Description limit the scope of invention, but rather by the Claims following herein.

What is claimed:

1. A system for monitoring and optimizing fluid extraction from geological strata comprising:
a flow transducer coupled to a modified check valve and adapted to generate flow signal data;
a temperature transducer coupled to the modified check valve adapted to generate temperature signal data;
a pressure transducer coupled to the modified check valve adapted to generate pressure signal data;
wherein said modified check valve is operatively coupled to a discharge conduit associated with a positive displacement walking beam type pumping unit; a local processing system electromagnetically coupled to said flow transducer, to the temperature transducer, and the pressure transducer including; a first processor; a first memory coupled to said first processor; and at least one application operatively stored in a portion of said first memory having logical instructions executable by said first processor to at least; monitor said flow signals generated by said flow transducer at least during operation of said positive displacement walking beam type pumping unit A/D conversion of said flow signals to create flow signal data; A/D conversion of said temperature signals to create temperature signal data; A/D conversion of said pressure signals to create pressure signal data; accumulate a portion of said flow signal data, said temperature signal data, and said pressure signal data, in another portion of said first memory, and transfer a portion of said accumulated flow signal data, temperature signal data, and said temperature signal data to an electronic transport medium; wherein said modification of the check valve, wherein the modification further comprises the steps of attaching a flow transducer, a temperature transducer, and a temperature transducer.

2. The system according to claim 1 further comprising;
another processing system including: a second processor; a data store coupled to said second processor; a second memory coupled to said second processor; and at least another application operatively stored in at least a portion of said second memory having logical instructions executable by said second processor to at least;
receive said accumulated flow signal data from said electronic transport medium,
receive said accumulated temperature signal data from said electronic transport medium,
receive said accumulated pressure signal data from said electronic transport medium,
retrievably store at least a portion of said accumulated flow signal data, temperature signal data, and pressure signal data, in said data store, output said accumulated flow signal data, temperature signal data, and pressure signal data, in a format useful for optimizing fluid extraction from said geological strata using said positive displacement walking beam type pumping unit.

3. The system according to claim 2 wherein said electronic transport medium includes one of; a telecommunications link, a laptop computer, a personal data assistant, or a data logging device.

4. The system according to claim 1 wherein said flow transducer generates said flow signals based at least in part on one of; variable reluctance effects, Hall effects, magnetic inductance effects, binary switch states, potentiometer outputs or piezoelectric effects.

5. The system according to claim 1 wherein said at least one application further includes instructions executable by said first processor for transmitting a control signal to an electromagnetically coupled motor controller associated with said positive walking beam type pumping unit, if said flow signal data, temperature signal data, and pressure signal data, fall outside a predetermined range or predetermined set point.

6. The system according to claim 5 wherein said control signal causes said motor controller to change an operating state of said positive displacement walking beam type pumping unit.

7. The system according to claim 6 wherein said operating state includes turning said positive displacement walking beam type pumping unit, on or off.

8. The system according to claim 6 wherein said predetermined range includes low or loss of fluid flow.

9. The system according to claim 5 wherein said predetermined set point includes a flow duration in which said positive displacement walking beam type pumping unit, has been operating or idle.

10. A system for monitoring and optimizing fluid extraction from geological strata comprising:
a flow transducer coupled to a modified check valve including means for generating flow signals by detecting flow induced movement of a position detectable element internal to said modified check valve;
a temperature transducer coupled to the modified check valve adapted to generate temperature signal data;
a pressure transducer coupled to the modified check valve adapted to generate pressure signal data; a local processing system electromagnetically coupled to said flow transducer, said temperature transducer, and said pressure transducer, and including means for; monitoring-a sensing element and said flow signals generated at least during operation of a positive displacement pump inline with said check valve; A/D conversion said flow signals to create digital flow signals; accumulating a portion of said flow signal data in a memory associated with said local processing system;
transferring a portion of said accumulated flow signal data to another processing system; electromagnetically coupling a motor controller associated with said positive displacement walking beam type pumping unit to said local processing system; generating a control signal if; said flow signal data fall outside a predetermined range, or said flow signal data fall outside a predetermined set point, or a control command is received from said another processing system; and, sending said control signal to said motor controller; wherein said motor controller changes an operating state of said positive displacement walking beam type pumping unit, upon receipt of said control signal, wherein said predetermined range is set to eliminate fluid pound.

11. The system according to claim 10 wherein said another processing system is in processing communications over a network with at least said local processing system and includes means for; receiving said accumulated flow signal data, pressure signal data, and said temperature signal data, from said network; retrievably storing a portion of said accumulated digitized flow signals in a data store; determining an optimum pumping cycle from said accumulated digitized flow signals; retrievably storing a portion of said accumulated digitized pressure signals in a data store;
determining an optimum pumping cycle from said accumulated digitized pressure signals; retrievably storing a portion of said accumulated digitized temperature signals in a data store; determining an optimum pumping cycle from said accumulated digitized temperature signals generating said control command; sending said control command to at least said local processing system; and outputting said optimum pumping cycle in a format useful for optimizing fluid extraction from said geological strata using said positive displacement walking beam type pumping unit.

12. The system according to claim 11 wherein said network is a wireless telecommunications network.

13. The system according to claim 10 wherein said motor controller further includes timer means for turning said positive displacement walking beam type pumping unit, on or off in accordance with a programmed pumping cycle.

14. The system according to claim 13 wherein said optimum pumping cycle is used to at least modify said programmed pumping cycle.

16. The system according to claim 13 wherein said programmed pumping cycle is modified manually by an operator.

17. The system according to claim 13 wherein said programmed pumping cycle is modified automatically by either said local processing system or said another processing system.

18. The system according to claim 11 wherein said another processing system further includes means for heuristically determining said optimum pumping cycle.

19. The system according to claim 10 where said transferring occurs automatically based at least in part on one of; time, in response to a transfer request or in response to an event.

20. The system according to claim 10 wherein said control command is generated based at least in part on one of: time or in response to an event.

21. A method of modifying check valves, said method comprising the steps of:
removing the flow monitoring portion of the check valve;
inserting into the flow monitoring portion of the check valve, a sensor, said sensor comprising a flow sensor, a temperature sensor, and a pressure sensor.

22. The method of modifying check valves according to claim 21 wherein the check valves are selected from a group comprising swing, lift, and wafer check valves.

23. The method of modifying check valves according to claim 21 wherein, said method having the sensor mounted in a forged bonnet, said forged bonnet is rated from 1500 lb to 2000 lb.

24. The method of modifying check valves according to claim 21 wherein said method having the sensor as a stand alone stainless steel housing,
said stand alone stainless housing further comprising two plates and a multiplicity of check valve bolts; wherein said sensor further comprises a first compartment and a second compartment, wherein the first compartment is screwed and stacked on the second compartment; and wherein the first and second compartment are inserted inside the two plates; and is bolted and sandwiched using the check valve bolts and plates.

25. The method of modifying check valves according to claim 21 wherein said method further includes a housing, said housing being divided into a top housing and a bottom housing;
said top housing further comprising a flow sensor, said flow sensor selected from a group consisting of a magnetometer, a thermocouple, a pressure transducer, a fluid sensor, a viscosity sensor, and a dielectric sensor;
so that the flow sensor may measure fluid properties such as viscosity, density and fluid make up such as water cut.

26. The method of modifying check valves according to claim 24 wherein said method further includes the steps of placing the sensing sections of three sensors so that they penetrate the lower housing; the check valve is further modified so that the temperature and pressure sensors penetrate the lower housing the check valve and the flow sensor will only rest behind the lower housing sensing the magnet attached to the plug or a magnetic plug; wherein said magnetic plug having the capability of moving up and down.

27. The method of modifying check valves according to claim 26 wherein said method further includes the steps of placing the sensing sections of three sensors so that they penetrate the lower housing; wherein an electrical interface belonging to each of three sensors will exit through a stainless steel one inch pipe from the upper housing; wherein the electrical interface will be electrically connected to an interface board; the interface board having the capability of analog signals to digital data; said digital data further being stored and transmitted to a data communications network.

28. The method of modifying check valves according to claim 26 wherein said method further includes using the modified lift check valve as: pump-off controlling, production monitoring, and steam injection monitoring.

29. The method of modifying check valves according to claim 28 wherein said method further comprises selected from a group consisting of:
for injection monitoring wherein using a flow chart, pressure and time during fluid injection into the reservoir are monitored, so that the injection data assists in estimating steam quality given flow pressure and temperature during injection;
using injectivity diagnostic graphs that are plotted in a manner similar to Hall injectivity plot so that the real time trending of Hall plot and real time calculation of slope will be monitored;
alarming and calculating events, such as plugging, fracturing, and other information such as radial flow and total skin factor.

30. The method of modifying check valves according to claim 28 wherein said method further comprises during production pump off controlling, recording the time that check valve stays open during pump plunger upward motion; as the rate of time that check valve stays open decreases, a pump off event is detected and the pump is turned off.

31. The method of modifying check valves according to claim 28 wherein said method further comprises the plotting of flow rate, temperature and pressure versus time.

32. The method of modifying check valves according to claim 28 wherein said method further comprises the monitoring of Monitoring of injection and also production from low permeability, high porosity diatomite resources during steamflood operations.
